(19) United States
(12) Patent Application Publication
(10) Pub. No.: US 2004/0159767 A1
(43) Pub. Date: Aug. 19, 2004

(54) Resilient mountings

(75) Inventors: Michael John Martin, Brookfield (AU); Wallace Colin Deskin, Redland Bay (AU); Christopher Douglas Brown, Victoria Point (AU)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: C&W Components Australia Pty. Ltd.

(21) Appl. No.: 10/627,097

(22) Filed: Jul. 25, 2003

(30) Foreign Application Priority Data
Jul. 30, 2002 (AU) 2002950458

(51) Int. Cl. F16M 3/00

(52) U.S. Cl. 248/638

(57) ABSTRACT

Vibration mounts (1) for automotive engines comprise spaced metal mounting brackets (2,4) are bonded to a MDI polyurethane cushioning medium (6) cast therebetween. The brackets (2,4) are marine grade stainless steel and are grit blasted before coating with a primer surfacing before the cushioning medium (6) is cast therebetween. After removal from a casting mould, the cushioning medium (6) in the brackets is subject to postcuring at 75°-150° C. for from 12-24 hours and thereafter is conditioned by storage at 15°-35° C. for a period of from 15-45 days to maximize the strength of the cushioning material.

### FIELD OF THE INVENTION

THIS INVENTION relates to improvements in resilient mountings to absorb vibrational energy from machinery, marine engines, automotive engines and the like.

The invention is concerned particularly, although not exclusively, with automotive engine and gearbox mounts.

### BACKGROUND OF THE INVENTION

Vibration absorbing mountings for engines and other machinery are well known. Typically these mounts comprise a pair of mild steel brackets having apertures therein to receive retaining bolts or the like. The mild steel brackets are separated typically by a block of rubber vulcanised to the spaced brackets during formation of the mounts.

While generally effective for their intended purpose, rubber cushioned mounts suffer greatly reduced life expectancy due to the presence of heat and oil typically found in an engine bay of a vehicle.

While it is known to replace rubber with a TDI polyurethane polymer as a vibration absorbing medium in vehicular shock absorber bushes, steering ball joints and steering assembly bushes, it is not known to use typical polyurethane polymers for engine mounts due to the relatively high cost of the polyurethane materials, capital cost of moulds and high labour overheads as well as the reduced resistance of such materials to the harsh environment of an engine bay.

U.S. Pat. No 5,788,207 describes an automotive transmission mount incorporating a polyurethane cushioning material but this requires the metal mounting brackets to be interlocked in the event of failure of the cushioning material.

While rubber based engine mounts are relatively inexpensive to purchase due to manufacture in low labour rate developing countries, these engine mounts, even when new, do not possess adequate physical properties such as tensile strength and tear strength to withstand torque loads when a motor vehicle engine is quickly revved.

In some performance vehicles, these torque loads are frequently sufficient to tear apart engine mounts immediately after installation without otherwise having been exposed to high temperatures and oil over a period of time.

Yet another problem is encountered by owners of performance vehicles who wish to enhance the engine bay of their vehicle by chrome plating or painting otherwise corrodible steel components to maintain their appearance.

Generally speaking it is not possible to electroplate rubber cushioned engine mounts as the exposure of the rubber material to a high temperature acid electroplating medium prematurely degrades the rubber cushioning medium. Similarly, it is not possible to effectively paint a rubber cushioned engine mount as flexure of the rubber cushioning material causes a paint film to crack and peel causing a visual impairment to what might otherwise be a well presented engine bay.

It is an aim of the present invention to overcome or ameliorate the disadvantages associated with prior art rubber cushioned vibration mounts including engine mounts.

It is an object of the present invention to provide an improved resilient mount for engines or the like wherein the mounts are capable of withstanding very high torque loads and harsh operating environments. It is also an aim of the present invention to provide an improved engine mount having an enhanced appearance which provides users with a convenient alternative choice to conventional rubber engine mounts.

### SUMMARY OF THE INVENTION

According to one aspect of the invention there is provided a vibration mount for machinery, said mount comprising:

spaced metal mounting brackets, each mounting bracket being adhesively anchored to a cured MDI polyurethane cushioning material cast therebetween, said mount characterized in that said metal mounting brackets have a bright corrosion resistant metal finish.

Suitably said polyurethane cushioning material is at least partially cross linked.

Preferably said polyurethane cushioning material is comprised of a polyester based, MDI terminated prepolymer reacted with a low molecular weight polyol.

Suitably said low molecular weight polyol is a diol.

The diol may be an aromatic diol or an aliphatic diol.

The cured polyurethane cushioning material may have a Shore A hardness in the range 75-90.

Preferably the cured polyurethane cushioning has a Shore A hardness in the range 75-85, most preferably in the range 78-82.

If required the cured polyurethane material may be coloured.

Suitably the cured polyurethane material may be transparent.

The metal mounting brackets may be electroplated with a corrosion resistant metal coating.

Preferably the metal mounting brackets are fabricated from stainless steel.

According to another aspect of the invention there is provided a method of manufacturing a vibration mount for machinery, said method comprising the steps of:

locating spaced metal mounting brackets in a mould to form a cavity therebetween;

introducing into said cavity a liquid MDI polyurethane cushioning material; and,

curing said polyurethane cushioning material at an elevated temperature until said cushioning material is at least partially cross linked and bonded to said mounting brackets.

Preferably, at least those surfaces of said mounting brackets intended to be bonded to said polyurethane cushioning material are coated with a primer surfacing before being located in said mould.

Suitably said primer surfacing is at least partially cured at an elevated temperature prior to introduction into said cavity of said cushioning material.

If required said vibration mounts may be postcured at an elevated temperature in the range of from 75° C. to 150° C. for a period of from 12 hours to 24 hours.

The vibration mounts produced according to the method of the invention may be conditioned by storage in a temperature range of from 15° C. to 35° C. for a period of from 15 to 45 days after removal from said mould.

### BRIEF DESCRIPTION OF THE DRAWINGS

In order that the various aspects of the invention may be more readily understood and put into practical effect, reference will now be made to a preferred embodiment described in the accompanying drawings in which:

FIG. 1 shows a cross-sectional view through an engine mount located in a casting mould; and

FIG. 2 shows comparative stress/strain curves for rubber and polyurethane mounts.

### DETAILED DESCRIPTION OF THE DRAWINGS

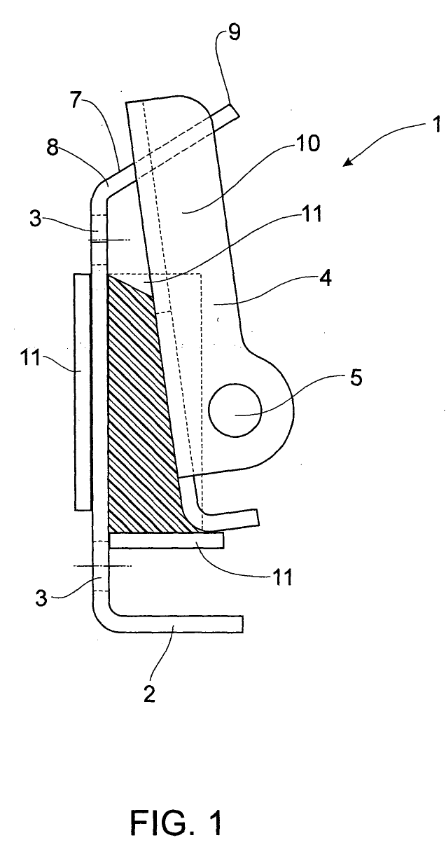

In FIG. 1, the engine mount 1 (of a “Chevrolet” (Trade Mark)) V8 engine comprises an engine mounting bracket 2 having mounting apertures 3 formed therein and a chassis mounting bracket 4 also having mounting apertures formed therein.

Brackets 2 and 4 are bonded to a MDI polyurethane vibration cushioning medium 6 cast therebetween. The upper end 7 of bracket 1 is formed with a narrow neck portion 8 having transversely extending ears 9 located inwardly of a slotted region 10 of bracket 4 such to enable a positive mechanical engagement between brackets 2 and 4 in the event of a failure of the typical rubber cushioning medium of the prior art engine mounts.

Although it is considered that engine mounts made in accordance with the invention may not need such a mechanical interengagement due to superior resistance to failure, the safety feature is retained for the sake of additional safety and otherwise to comply with any applicable automotive design regulations.

Although brackets 2 and 4 could be manufactured from mild steel plated with chrome, zinc or cadmium plated mild steel, it is preferred to use a general purpose or marine grade stainless steel plate, typically of 3 mm in thickness in a conventional die stamping and pressing operation to shape the brackets.

As a preliminary step, the surfaces of the metal brackets 2, 4 to which the cushioning medium will be bonded are cleaned of any foreign material such as lubricating oils or greases and any metal oxide film by a coarse grit blasting process which not only cleans the surface but also increases the surface area by roughening it substantially. Alternatively, the surface of the brackets may be cleaned by electro-polishing.

An MDI polyurethane primer such as Chemlok 213 or Chemlok 213/219 (Trade Marks) is applied to the bonding surfaces of the brackets 2, 4 which are then prebaked at 120° C. for 1½-2 hours to at least partially cure the primer.

Preferably the brackets 2, 4 are mounted in steel mould 11 during prebaking to bring the mould surfaces to the same temperature as the brackets 2, 4.

A quantity of VIBRATHANE 8094 (Trade Mark), a polyester based, MDI terminated liquid polyurethane prepolymer, is then preheated to about 70±10° C. before mixing with 1,4 Butanediol in the ratio of 100 parts of prepolymer to 8-6 parts of polyol. The resultant mixture is then poured into the mould and allowed to cure at 120±10° C. for one hour before removal of the mount 1 from the mould. Mount 1 is then postcured at a temperature of 120±10° C. for 10-20 hours, preferably about 15-16 hours and subsequently the mount is then allowed to cool to ambient temperature.

After conditioning for a minimum of 7 days but preferably for about 30 days at 24° C. and 50% relative humidity, the following physical properties can be expected:

| Hardness, Shore A | 85 | |
|---|---|---|
| 100% modulus | 1456 | psi |
| 300% modulus | 2980 | psi |
| Tensile Strength | 6125 | psi |
| Elongation at Break | 480% | |
| Bushore Rebound | 0.43% | |
| Tear Strength (ASTM D-470) | 30.84 | kn/m |
| Tear Strength Die C | 780 | kn/m |
| Compression Set, Method B | 0.33 | |
| after 22 hours @ 70° C. | | |
| Specific gravity | 1236 | gm/cc |

| | |
|---|---|
| Colour | Clear |

The mounts were tested for strength by mounting bracket 2 to a base plate clamped in a lower jaw of a tensile tester such as an “Instron” tensometer or the like.

A tubular member, attached to bracket clamped in the upper jaw, was secured to bracket 4 by a bolt passing through apertures 5.

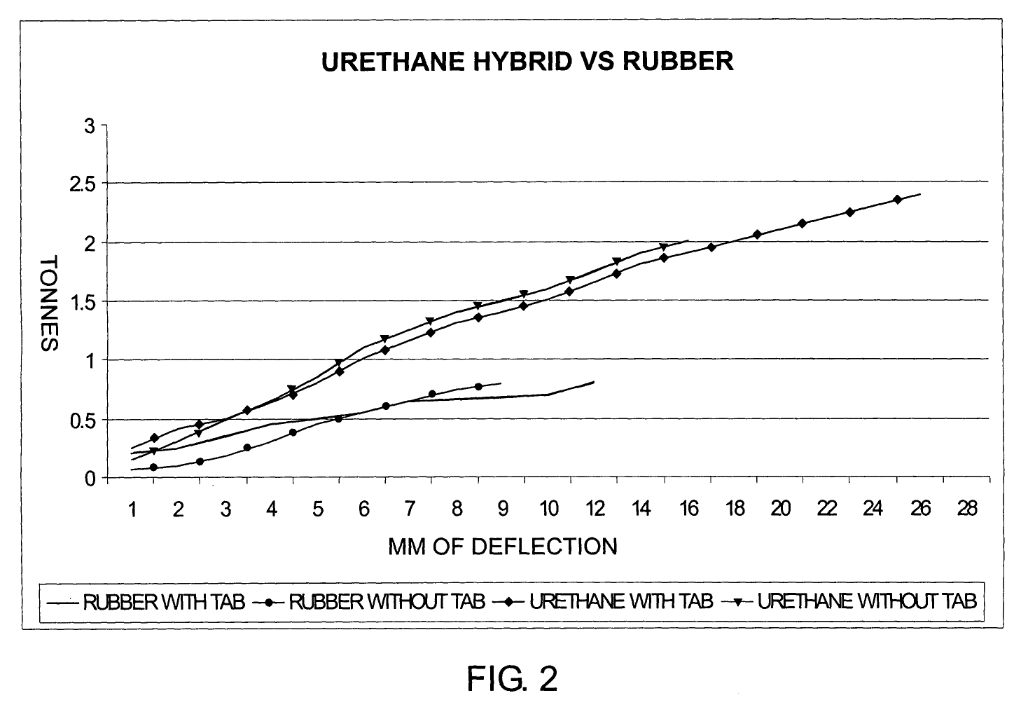

FIG. 2 shows comparative load vs deflection curves for the polyurethane mounts according to the invention vs conventional prior art rubber mounts.

As will be readily apparent to a person skilled in the art both the flexural modulus and the tensile strength of the polyurethane mounts are superior with the polyurethane mounts exhibiting tensile strength values of from four to five times that of the rubber mounts at failure.

Another significant advantage of engine mounts according to the invention is that conventional TDI polyurethane, when subjected to vibrational forces over a sustained period of time, develops a substantial internal temperature due to flexure. Over time, this internally generated heat causes progressive hardening of the polyurethane mass and ultimately failure due to thermal degradation of the polyurethane polymer. This is exacerbated when TDI polyurethanes are used as engine mounts in a hot vehicle engine bay.

MDI polymers according to the invention, when allowed to age for about 30 days develop a small degree of cross linking but otherwise do not appear to generate the same internal heat due to flexure as TDI polymers. Accordingly, apart from having superior strength and flexural properties, engine mounts according to the present invention are expected to exhibit greater durability in the harsh environment of a vehicle engine bay.

By manufacture of the engine mounts with stainless steel mounting brackets, it is possible to submit the cured or conditioned engine mounts to a conventional electro-polishing process to obtain a bright metallic finish without any degradation of the polyurethane material bonded therebetween.

As the polyurethane material is clear, it is possible to incorporate a pigment, dye or other colouring into the liquid mix before pouring into the mould. The coloured polymer may act merely in a decorative sense to complement the appearance of the engine bay or differing colours may be employed to distinguish engine mounts of differing vehicles.

By using a marine grade stainless steel, engine mounts according to the invention may be employed in marine applications.

Throughout this specification, unless the context requires otherwise, the word “comprise”, and variations such as “comprises” or “comprising”, will be understood to imply the inclusion of a stated integer or group of integers or steps but not the exclusion of any other integer or group of integers.

1. A method of manufacturing a vibration mount for machinery, said method comprising the steps of:
locating spaced metal mounting brackets in a mould to form a cavity therebetween;
introducing into said cavity a liquid MDI polyurethane cushioning material; and,
curing said polyurethane cushioning material at an elevated temperature until said cushioning material is at least partially cross linked and bonded to said mounting brackets.

2. A method as claimed in claim 1 wherein at least those surfaces of said mounting brackets intended to be bonded to said polyurethane cushioning material are coated with a primer surfacing before being located in said mould.

3. A method as claimed in claim 2 wherein said primer surfacing is at least partially cured at an elevated temperature prior to introduction into said cavity of said cushioning material.

4. A method as claimed in claim 1 wherein said vibration mounts are postcured at an elevated temperature in the range of from 75° C. to 150° C. for a period of from 12 hours to 24 hours.

5. A method as claimed in claim 1 wherein said vibration mounts are conditioned by storage in a temperature range of from 15° C. to 35° C. for a period of from 15 to 45 days after removal from said mould.

6. A method as claimed in claim 2 wherein said mounting brackets are grit blasted prior to coating with primer surfacing.

7. A method as claimed in claim 6 wherein said mounting brackets are electro-polished after bonding of said cushioning material thereto.

8. A vibration mount for machinery, said mount comprising:
spaced metal mounting brackets, each mounting bracket being adhesively anchored to a cured MDI polyurethane cushioning material cast therebetween, said metal mounting brackets having a bright corrosion resistant metal finish.

9. A vibration mount as claimed in claim 8 wherein said polyurethane cushioning material is at least partially cross-linked.

10. A vibration mount as claimed in claim 8 wherein said polyurethane cushioning material is comprised of a polyester based, MDI terminated prepolymer reacted with a low molecular weight polyol.

11. A vibration mount as claimed in claim 10 wherein said low molecular weight polyol is a diol.

12. A vibration mount as claimed in claim 11 wherein said diol is an aromatic diol or an aliphatic diol.

13. A vibration mount as claimed in claim 8 wherein said cured polyurethane cushioning material has a Shore A hardness in the range 75-90.

14. A vibration mount as claimed in claim 13 wherein said cured polyurethane cushioning has a Shore A hardness in the range 75-85.

15. A vibration mount as claimed in claim 14 wherein said cured polyurethane cushioning has a Shore A hardness in the range 78-82.

16. A vibration mount as claimed in claim 8 wherein said cured polyurethane material is coloured.
